(19) United States
(12) Patent Application Publication
(10) Pub. No.: US 2014/0301719 A1
(43) Pub. Date: Oct. 9, 2014

(54) PROCESSING CACHE FOR MULTIPLE BIT PRECISIONS

(71) Applicant: Broadcom Corporation, Irvine, CA (US)

(72) Inventors: Larry Alan Pearlstein, Newtown, PA (US); Alan Robert Morgan, Milton (GB); Nicholas John Hollinghurst, Cambridge (GB)

(21) Appl. No.: 13/928,258

(22) Filed: Jun. 26, 2013

Related U.S. Application Data
(60) Provisional application No. 61/809,553, filed on Apr. 8, 2013.

(51) Int. Cl. H04N 5/907; H04N 5/91

(52) U.S. Cl. CPC H04N 5/907; H04N 5/91
USPC 386/326

(57) ABSTRACT

The present disclosure relates generally to system and method of data processing that may provide for efficient use of on-chip cache for processing data having a first bit precision and a second bit precision. In some implementations an on-chip cache is configured to store integer data corresponding to a first bit precision in an integer tile and fractional data corresponding to a difference in bit precision between a second bit precision and the first bit precision in a hybrid memory tile.

### TECHNICAL FIELD

The present disclosure relates generally to a system and method for processing data having a first bit precision and a second bit precision.

### BACKGROUND

In recent years video technology has changed rapidly. One drawback of the rapid innovations in video processing is that many devices are unable to efficiently implement newer video processing techniques while maintaining legacy techniques. In response to these rapid changes, video processing devices may be required to efficiently process video data corresponding to previous methods as well as state of the art methods.

### BRIEF DESCRIPTION OF THE DRAWINGS

FIG. 1 shows an example of a method 102 for processing data having a first bit precision and a second bit precision;

FIG. 2 shows an example of a block diagram of an on-chip cache configured to store video data having data elements of a first bit precision and data elements of a second bit precision;

FIG. 3 shows an example of a block diagram of a system for encoding video data having data elements of a first bit precision and data elements of a second bit precision;

FIG. 4 shows an example of a flow chart of a method for encoding video data having data elements of a first bit precision and data elements of a second bit precision;

FIG. 5 shows an example of a block diagram of a system for decoding a video bit stream having data elements of a first bit precision and data elements of a second bit precision;

FIG. 6 shows an example of a flow chart of a method for decoding video data having a first bit precision and a second bit precision;

FIG. 7 shows an example of a block diagram of an integrated circuit comprising a video encoder;

FIG. 8 shows an example of a block diagram of an integrated circuit comprising a video decoder;

FIG. 9 shows an example of a flow chart of a method for encoding video data having a first bit precision and a second bit precision; and

FIG. 10 shows an example of a flow chart of a method for decoding video data having a first bit precision and a second bit precision.

### DETAILED DESCRIPTION

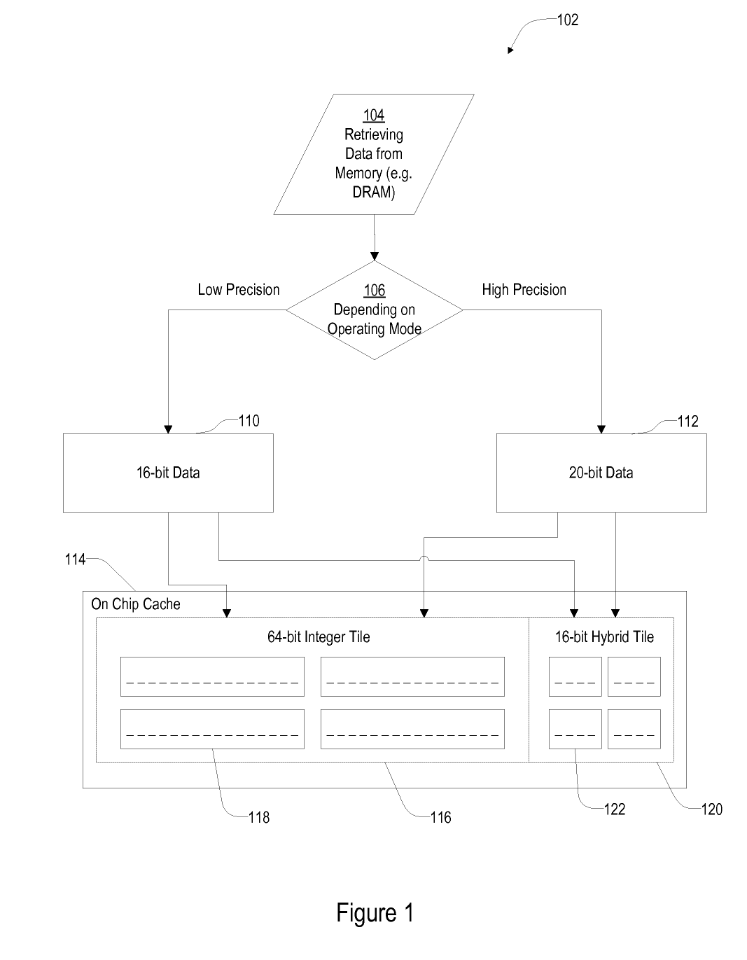

FIG. 1 shows an example of a method 102 for processing data having a first bit precision and a second bit precision. The method may begin by retrieving data from memory (e.g. DRAM) (104). The data may comprise a first stream having data elements of a first bit precision and second stream having data elements of a second bit precision. Upon retrieval of the data, the data may be processed in a high precision mode or a low precision mode (106). A processor may distinguish between the streams of data comprising a first bit precision and a second bit precision. The first bit precision may correspond to low precision data 110 and the second bit precision may correspond to high precision data 112.

The precision of the first bit precision and the second bit precision may be identified by reading header information from the data in the processor. In some implementations, identifying the precision of each unit of data received may comprise the delivery of a separate data packet in the data. The separate data packet may define an algorithm or other identifying information that may be interpreted by the processor to determine the bit precision of the data being received. The processor in this implementation is referred to generally, but may comprise a video encoder or decoder capable of processing video data. It is contemplated that the methods and systems disclosed herein may be applicable to a variety of processing devices including, but not limited to, a general purpose processor, encoders, decoders, graphics processing units (GPU), frame rate converters, and other similar devices. A method and apparatus for receiving a video data signal where each pixel is represented by one or more digitized components has been disclosed in U.S. Pat. No. 8,306,122, which is commonly owned by the assignee of the present application, and the contents of which are incorporated herein by reference in their entirety.

Once the bit precision of each unit of data has been identified, the data may be stored into a cache. In this example, the cache may comprise on-chip cache 114. The data in this example may comprise a low precision bit stream and a high precision bit stream. In this example, the low precision bit stream may correspond to 16-bit data 110 comprising the sixteen integer bits and the high precision bit stream may correspond to 20-bit data 112. The 20-bit data may further comprise sixteen integer bits and the four fractional bits.

An integer memory tile 116 may comprise a plurality of integer storage elements 118 for example for storing 16-bit data. A hybrid memory tile 120 may comprise a plurality of hybrid storage elements 122 corresponding to the difference between the first bit precision 110 and the second bit precision 112, for example for storing 4-bit data. The term tile may refer to at least one address in memory and may refer to a continuous set of addresses. For example, a tile may comprise a plurality of addressable storage elements in the cache.

The terms integer data and fractional data as referred to herein may correspond to a bit precision (bit width) of the data. A unit of data having a first bit precision may comprise a first bit width corresponding to integer data. A unit of data having a second bit precision may comprise a second bit width corresponding to integer data and fractional data. The integer data of a unit of data having the second bit precision may comprise the most significant bits while the fractional data may comprise the least significant bits. The difference in bit precision (bit width) between the first bit precision and the second bit precision may generally define the fractional data of a unit of data.

Each unit of 16-bit data received by the processor may be stored in an integer tile 116. The integer tile 116 may further comprise a plurality of addressable storage elements defining integer storage elements 118 in the on-chip cache 114. Each integer storage element may comprise exactly the capacity to store one unit of integer data, sixteen bits in this example. Each unit of 16-bit data may further be stored in a hybrid storage tile 120 utilizing a plurality of hybrid storage elements 122. In this case, four hybrid storage elements may be configured to store 16-bits of data corresponding to a unit of integer data.

Each unit of 20-bit data received by the processor may be separated into an integer part and a fractional part. The first 16-bits (the integer part) of each unit of 20-bit data may be stored in an integer storage element 118 of the integer tile 116 or a plurality of hybrid storage elements 122 of the of the hybrid tile 120. The remaining 4-bits (the fractional part) may be stored in a hybrid storage element 122 of the hybrid tile 120. The flexible application of the hybrid storage elements 122 of the hybrid tile 120 may provide for efficient utilization of cache for processing data having both a first precision and a second precision.

The 20-bit data may further be defined as pixel component data comprising 16-bit pixel component data, defining an integer part. The integer part may further correspond to the most significant bits of the 20-bit data. The pixel component data may further comprise 4-bit pixel component data, defining a fractional part. The fractional part may further correspond to the least significant bits of the 20-bit data. The integer 118 and fractional 122 storage elements may comprise a plurality of addressable storage elements, dynamic memory locations (e.g. on-chip dynamic memory), or other memory structures in an on-chip cache. The methods and systems described herein may provide for efficient implementation of a cache for video data comprising a first bit precision 110 and a second bit precision 112.

In many systems, if data is received that does not correspond to a native bit precision of an on-chip cache, the data having a higher or lower precision than the native operation may cause significant waste of addressable storage elements. For example, in the instant example 102, if the hybrid tile 120 was not configured to receive the fractional data 122, when receiving 20-bit data, two integer storage elements 118 would be required to store a single 20-bit data unit. Similarly, if the integer tile was configured having a plurality of 20-bit storage elements, storing 16-bit data would waste 4-bits of storage in each addressable storage element in an on-chip cache. These examples may illustrate that the flexible implementations disclosed herein may provide for improved efficiency in implementing on-chip cache when processing video data comprising more than one bit width.

The data in this example comprises a first bit precision of 16-bit data 110 and a second bit precision of 20-bit data 112. Though specific bit precisions are referred to herein, it is understood that the specific precisions discussed may be generalized as a first precision and a second precision. The disclosed methods and systems may be equally applicable to other bit precisions including 8 and 10-bits, 12 and 16-bits, 16 and 20-bits, 24 and 30-bits . . . 80 and 100-bits, etc. The implementations disclosed may be adapted to applications for various bit precisions related to the encoding and decoding of video data and more particularly may be adapted to process video streams having a first bit precision and a second bit precision. In other implementations the methods and systems may provide for operation of a video codec capable of selectively processing video data at a first bit precision and a second bit precision.

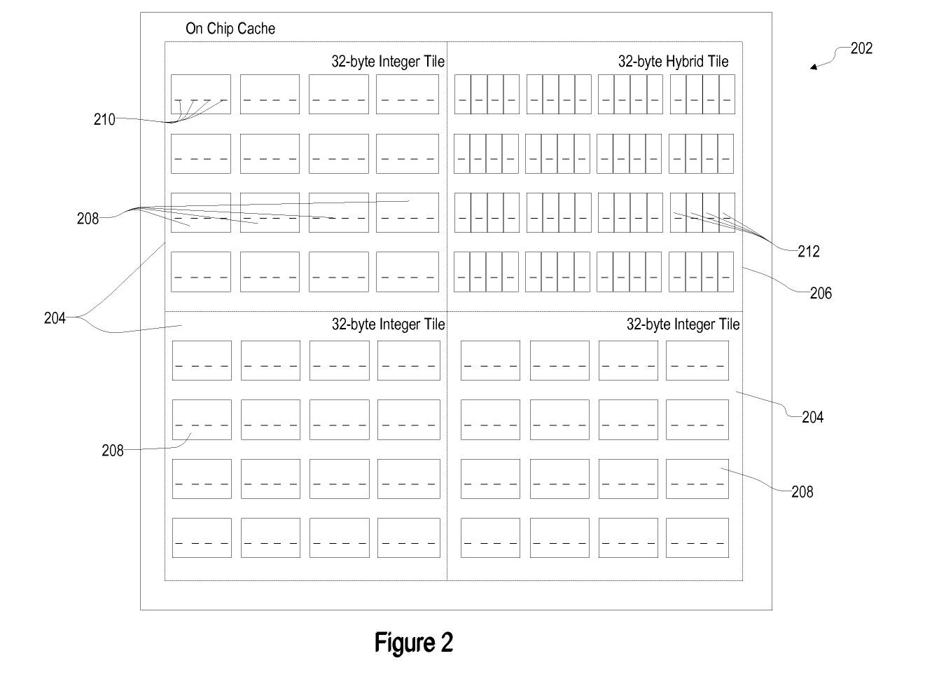

FIG. 2 shows an example of a block diagram of an on-chip cache configured to store video data having data elements of a first bit precision and data elements of a second bit precision. Reference numerals for similar elements in FIG. 2 are omitted for clarity. The on-chip cache 202 in this implementation may generally comprise three integer tiles 204 and one hybrid tile 206. Each of the integer tiles 202 may be configured for dynamic storage of 32-bytes of integer data with each integer storage element 208 comprising 16-bit storage elements. Each part of the storage elements 210 of the on-chip cache 202 may represent 4-bit storage elements for clarity.

The hybrid tile 206 may be configured for dynamic storage of fractional data corresponding to the integer data stored in the integer tiles 204 with each hybrid storage element 212 comprising 4-bit storage elements. The hybrid tile may also be configured to store integer data comprising 16-bit integer data in 4 hybrid storage elements 212. In this example, the on-chip cache 202 may receive a plurality of 16-bit data units and 20-bit data units. The 16-bit data units may comprise pixel component data and each unit may be stored in an individual integer storage element 208. The 20-bit data units may comprise pixel component data and each may be stored in an individual integer storage element 208 for the sixteen most significant bits and an individual hybrid storage element 212 for the four least significant bits. The on-chip cache 202 may provide for efficient storage of 16-bit data and 20-bit data.

For simplicity, in the following example, only 20-bit data will be referred to, however, it shall be understood with regard to this disclosure that the on-chip cache is equally well-suited to efficiently store both 16-bit data and 20-bit data. As the 20-bit data is received by a processor and stored in the on-chip cache 202, each 20-bit data unit will be split into a 16-bit integer data unit and 4-bit fractional data unit. Each 16-bit integer data unit and 4-bit fractional data unit may then be stored in an integer storage element 208 and a hybrid storage element 212, respectively. As the pixel component data is stored in the on-chip cache by the processor, the three integer tiles and the first three rows of hybrid tiles may become occupied. This efficient use of the on-chip cache may be applied to various implementations comprising bit streams having various combinations of bit precisions.

The on-chip cache discussed herein may comprise a plurality of on-chip storage elements that may be accessed as an on-demand cache. The on-demand cache may comprise tags to identify specific data allocated to a particular addressable storage element. These tags may provide for accessing and writing data to particular addressable storage elements in a predictable sequence. In some implementations, the on-chip cache may comprise a plurality of on-chip storage elements accessed as a managed cache (e.g. a stripe buffer). The managed cache may provide for access to a particular addressable storage element during a scanning procedure of the on-chip cache rather than by direct access.

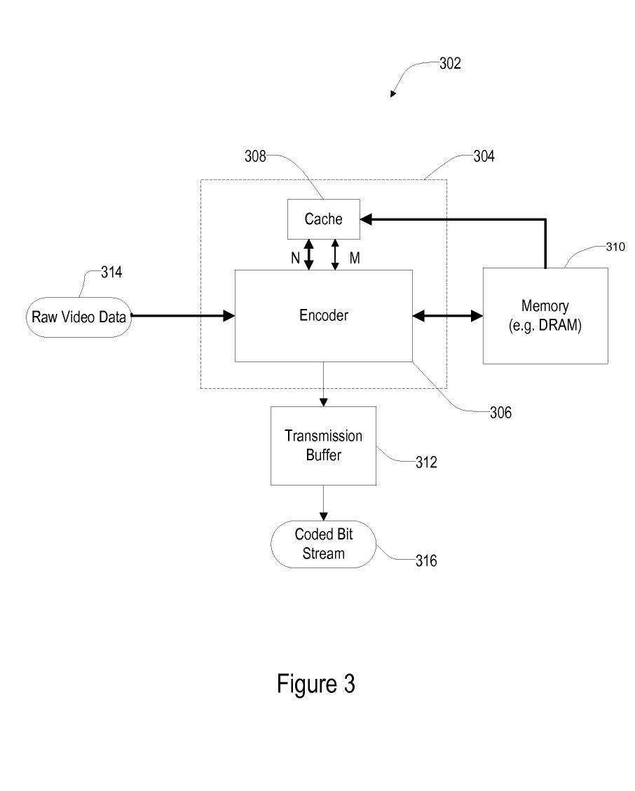

FIG. 3 shows an example of a block diagram of a system for encoding video data having data elements of a first bit precision and data elements of a second bit precision. The system 302 may generally comprise an encoder unit 304 comprising an encoder 306 and an on-chip cache 308. The system may further comprise memory 310, such as DRAM, and a transmission buffer 312 operably coupled to the encoder unit 304. Upon receipt of raw video data 314, the encoder 306 may buffer the video data 314 comprising a plurality of video images in memory. The encoder 306 may further be configured to selectively fetch pixel component data corresponding to previously encoded frames from the memory 310 and store the pixel component data into the on-chip cache 308 for processing and transmitting a coded bit stream 316.

The encoder 306 may be configured to efficiently encode and transmit data having a first bit precision, second bit precision, or comprising both first and second bit precisions in response to a system mode received from a system processor or controller. The encoder 306 may generate the coded bit stream by applying various encoding algorithms to generate a coded bit stream. In order to provide for efficient video encoding 306 under a plurality of bit precisions, the on-chip cache 308 may be configured to receive and dynamically store pixel component data comprising integer data and fractional data. The integer data may correspond to a first bit precision of width N, and the fractional data may correspond to a bit precision of width M. The integer data may correspond to the most significant bits of the pixel component data and the fractional data may correspond to the least significant bits of the pixel component data.

The pixel component data having the first bit precision, N, may be stored in an integer tile or a hybrid tile comprising a plurality of addressable storage elements in the on-chip cache 308 for processing a low precision coded video stream. The pixel component data having the second bit precision, N+M, may be divided into two parts comprising integer data, N, and fractional data, M. The integer data may be stored in an integer tile comprising a plurality of integer storage elements corresponding to the first bit precision, N. The fractional data may be stored in a fractional tile comprising a plurality of hybrid storage elements corresponding to the difference between the first bit precision (N) and the second bit precision (N+M), the difference being M. Similar to the methods introduced in FIGS. 1 and 2, the system may provide for efficient storage and encoding of pixel component data having a first or a second bit precision.

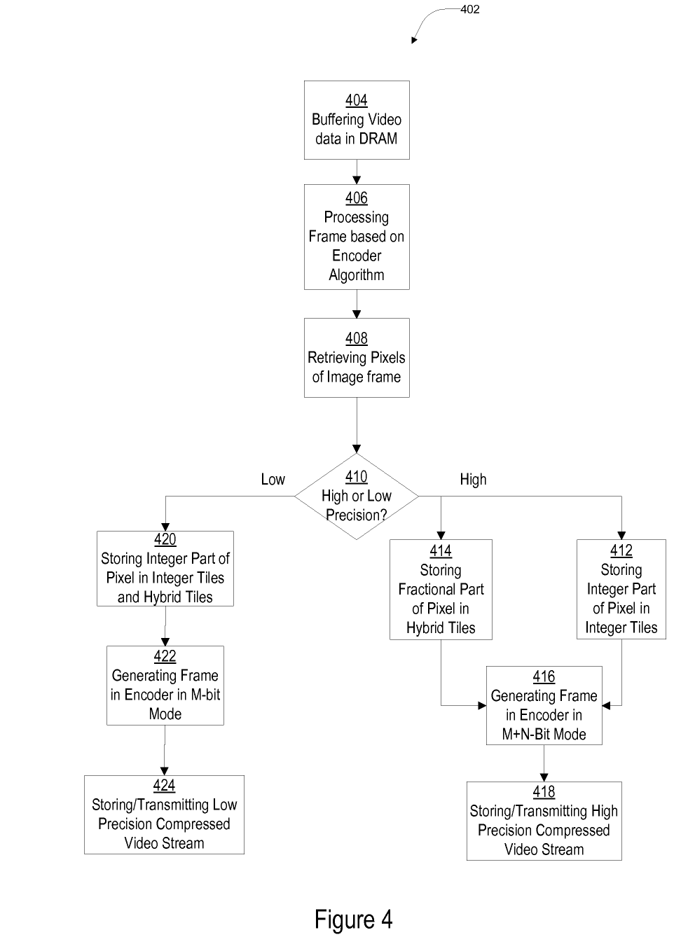

FIG. 4 shows an example of a flow chart of a method 402 for encoding video data having data elements of a first bit precision and data elements of a second bit precision. The method 402 of encoding video data may begin in response to the receipt a video stream comprising a plurality of image frames in an encoder. The video data of the video stream may first be buffered into the memory, for example DRAM (404). Once the video data is buffered in the memory, encoding of the video data may begin processing an image frame. The image frame may be encoded based on an encoder algorithm as one of a plurality of frame types (406). For example, a frame type may comprise an independent or intra-coded frame (I-frame). Another example of a frame type may comprise a dependent frame, such as a predicted picture frame (P-frame), a bi-predictive picture frame (B-frame) or other types of dependent coded image frames. P-frames and B-frames may be dependent on one or more reference frames.

Once the frame type is determined, the encoder may then retrieve image frame pixels from the memory (408). At this stage, the system may selectively encode the data in high precision mode, or a low precision mode (410). This selection may be based on the encoder algorithm and the desired precision of the coded bit stream. The selection may also be made in response to one or more operating modes of a system. Operating modes may comprise a plurality of conditions of system operation. For example a system may operate in a low precision mode to preserve processing power, battery life, and system performance attributes, such as memory, cache, etc. A system may also operate in a high precision mode under various conditions. For example, a system may operate in a high precision mode in response to sufficient processing power being available to encode a video stream in real-time while maintaining a target frame rate. In another example, a system may operate in a high precision mode when the system has sufficient battery life or when connected to an electrical power supply, such as an alternating current (AC) power supply.

The method 402 may selectively encode data in the low precision mode comprising integer data, N. The method may also encode data in the high precision mode having a precision of N+M. The high precision data may comprise integer data, N, and fractional data, M. The decision to encode the video signal in low precision mode may be in response to one or more system modes including a user-defined coding preference, a power saving mode configured to limit power usage during encoding, or the compatibility of a destination device to decode video. Once the mode of encoding operation is determined, the encoder may configure a plurality of hardware configuration bits to control the arrangement of the pixel component data among the plurality of integer and hybrid storage elements.

In the high precision mode of operation, an encoder may store the integer part of the pixel component data in an integer tile of the on-chip cache (412). The encoder may further store the corresponding fractional part of the pixel component data in a hybrid tile of the on-chip cache (414). Once the data is stored in the on-chip cache, the encoder may access the integer part of the pixel component data and the corresponding fractional part of the pixel component data to generate a compressed video frame in high precision mode (416). Following the encoding of the compressed video frame, the encoder may buffer and transmit a compressed high precision video stream (418).

In the low resolution precision mode of operation, the encoder may store the integer part of the pixel component data in an integer tile or a hybrid tile of the on-chip cache (420). The integer part may then be accessed by the encoder to generate a compressed video frame in low precision mode (422). The compressed video frame may then be stored or transmitted as a low precision video stream (424). By applying fractional tile storage elements flexibly for both integer and fractional data storage, the disclosure may provide for efficient utilization of cache for encoding data having a first or second bit precision.

In various forms of video encoding, the compression format (e.g. MPEG-2, MPEG-4, H.264, Theora, Dirac, etc.) may provide for motion estimation, wherein each image frame may be dependent on one or more other frames of a compressed data stream. For simplicity, the previous implementations introduced herein may refer to a single image frame being retrieved in the encoding process. However, the implementations are equally applicable to various video compression methods employing multiple reference frames and various forms of motion estimation, entropy encoding, luma and chroma sampling, etc.

Though the terms first bit precision and second bit precision are used herein to describe video data comprising a first bit width and a second bit width, the disclosed methods and systems are equally applicable to other forms of data having more than one bit precision. Some other forms of data include but are not limited to packets, sets, sequences, datagrams, segments, blocks, cells or frames of data. While the exemplary implementations disclosed teach of systems relating to streaming video, the systems and methods disclosed may also be applicable to communication and transmission of data generally.

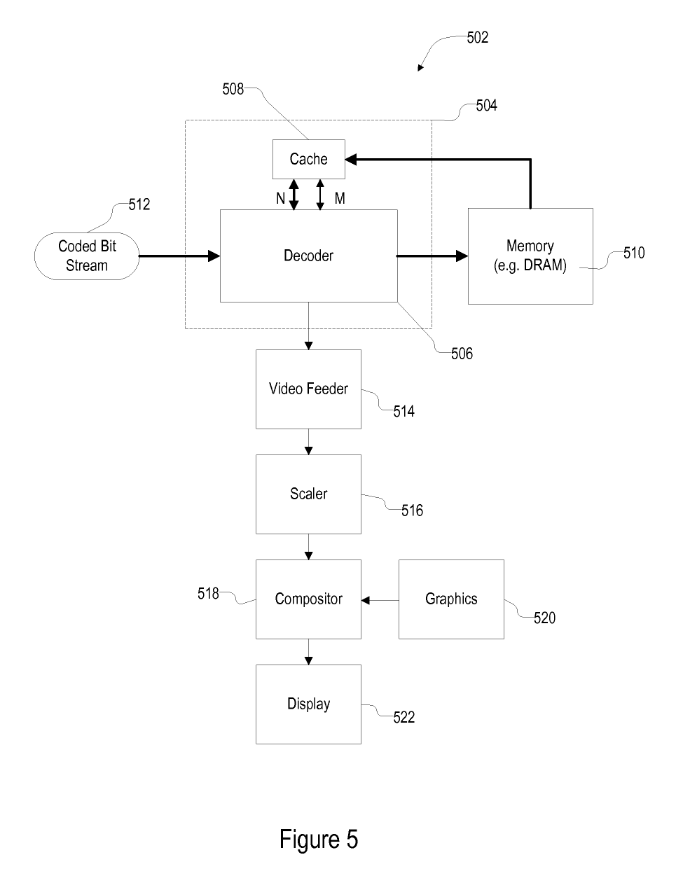

FIG. 5 shows an example of a block diagram of a system for decoding a video bit stream having data elements of a first bit precision and data elements of a second bit precision. The system 502 may generally comprise a decoder unit 504 comprising a decoder 506 and an on-chip cache 508. The system may further comprise a memory 510 operably coupled to the decoder unit 504. Upon receipt of a coded bit stream 512, the decoder 506 may buffer the decoded image frames from the coded bit stream 512 to the memory 510. The decoder 506 may be configured to selectively fetch previously decoded pixel component data corresponding to each image frame from the memory 510 and store the previously decoded pixel component data into the on-chip cache 508 for generating an output video signal.

The decoder 506 may be configured to efficiently generate video having a first bit precision or a second bit precision in response to a system mode. The system mode may be controlled by a system processor, controller (not shown), or the precision of the coded bit stream 512 received by the decoder 506. Similar to the encoding implementation of FIG. 3, the decoding unit 504 may be configured to store pixel component data having a first bit precision, N, and a second bit precision, N+M. The pixel component data having the first bit precision, N, may be stored in a set of on-chip addressable storage elements in the on-chip cache 508 comprising integer storage elements in an integer tile or a plurality of hybrid storage elements in a hybrid tile. The pixel component data having the second bit precision, N+M, may be stored in the on-chip cache 508 in integer storage elements corresponding to the N most significant bits and fractional storage elements corresponding to the M least significant bits.

The determination of the decoder to reconstruct the coded bit stream in a low precision mode using integer data or in a high precision mode using integer and fractional data may be based on the precision of the data received, the resolution of the display device, or due to a system condition, such as a power saving mode. The precision of the data received may be determined from header information incorporated into the compressed frames of the coded bit stream. Once the coded bit stream is reconstructed by the decoder, a raw video signal may be fed through a video feeder 514 to control the video frame rate, and scaled in a scaler 516. The scaled video data may then be rendered in a compositor to add additional graphics information to the video stream. A reconstructed video feed may finally be output to a display device 522 for viewing.

In some implementations, the decoder 506 may determine the precision of the data received from header information read from each of the compressed image frames. In some implementations, the header information may be identified by a translator block in communication with a decoder. The translator block may receive the coded bit stream in parallel to the encoder. The translator may further translate the header block information for each compressed frame of the coded bit stream. Upon determining the bit precision of each frame as well as other frame compression information, the translator may communicate the precision of the frame and the other compression information to the decoder. The compression information may include motion compensation data relating at least one image frame to another image frame.

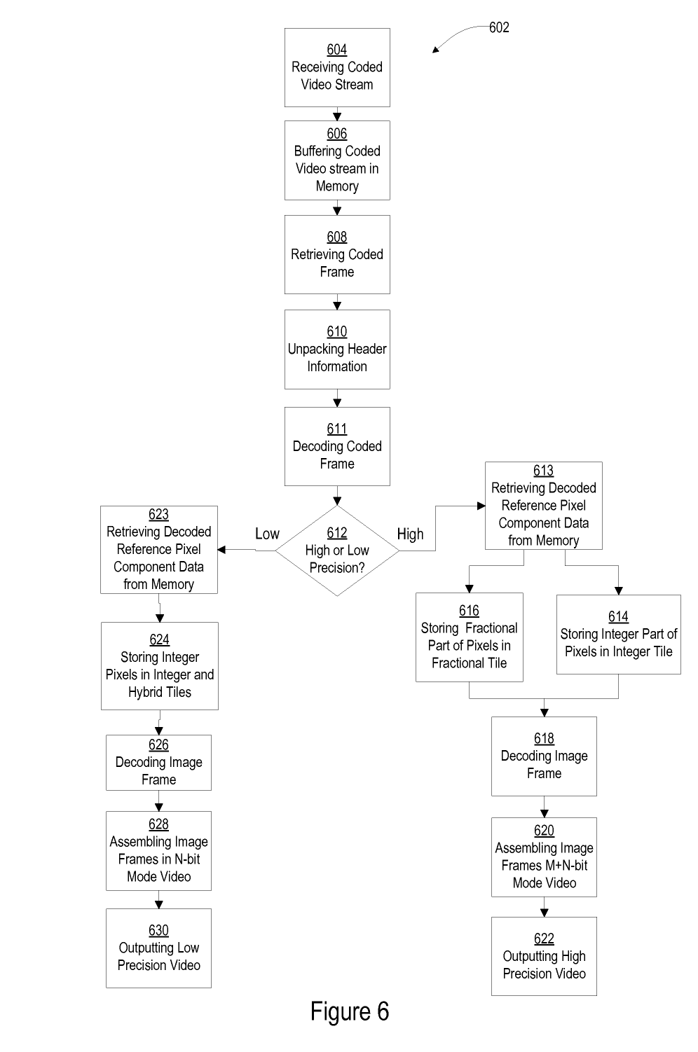

FIG. 6 shows an example of a flow chart of a method 602 for decoding video data having a first bit precision and a second bit precision. The method 602 of decoding a compressed video stream may be initiated in response to the receipt of a coded video stream (604). The coded video stream may comprise a plurality of compressed image frames. The compressed image frames may be supplied to a decoder and buffered in memory (606). Once the compressed image frames are buffered in memory, the decoder may retrieve an image frame (608). Header information may then be unpacked from the incoming coded video stream (610).

From the header information, the decoder may determine whether the compressed video stream was coded in a low precision mode or a high precision mode. Initially, an independent frame may be decoded, and the decoded pixel component data may be stored to memory (611). The decoded pixel component data of the independent frame may be used as reference data to decode dependent frames. The decoder may then proceed to decode dependent frames in a high precision mode or a low precision mode (612).

If the system is designated to reconstruct the video signal in a high precision mode, the decoder may retrieve decoded reference pixel component data from memory (613). The decoder may then separate the integer, N, and fractional, M, parts of the decoded reference pixel component data. The integer part of the pixel component data comprising N-bit data may then be stored in a plurality of integer storage elements in cache (614). The fractional part of the pixel component data comprising M-bit data may be stored in a plurality of hybrid storage elements in cache (616). Once the integer and fractional parts of the pixel component data of the decoded frames are stored in the on-chip cache, the decoder may reconstruct each dependent image frame (618). The image frames may then be assembled in N+M-bit, high precision mode to generate a high precision video feed (620). The video feed may then be output as high precision video (622).

If the system is designated to reconstruct the video signal in a low precision mode, the decoder may retrieve decoded reference pixel component data from memory (623). Each unit of N-bit integer data may be stored in a single integer storage element or a plurality of hybrid storage elements (624). If the system receives high precision data, but selects low precision operation, the low precision data may be stored in a single integer storage element or a plurality of hybrid storage elements. The fractional part of the high precision data may be truncated to eliminate the unused portions of the pixel component data. In some implementations, the fractional data may also be rounded and combined with the integer data. Some implementations may also provide for inverse rounding methods to be applied allowing for high precision, N+M bit, data to later be recovered. Once the integer part of the pixel data from each previously decoded image frame is stored in the on-chip cache, the decoder may reconstruct each dependent image frame (626). The decoded image frames may then be reconstructed in the N-bit, low precision mode (628). A low precision video feed may then be output to a video display (630).

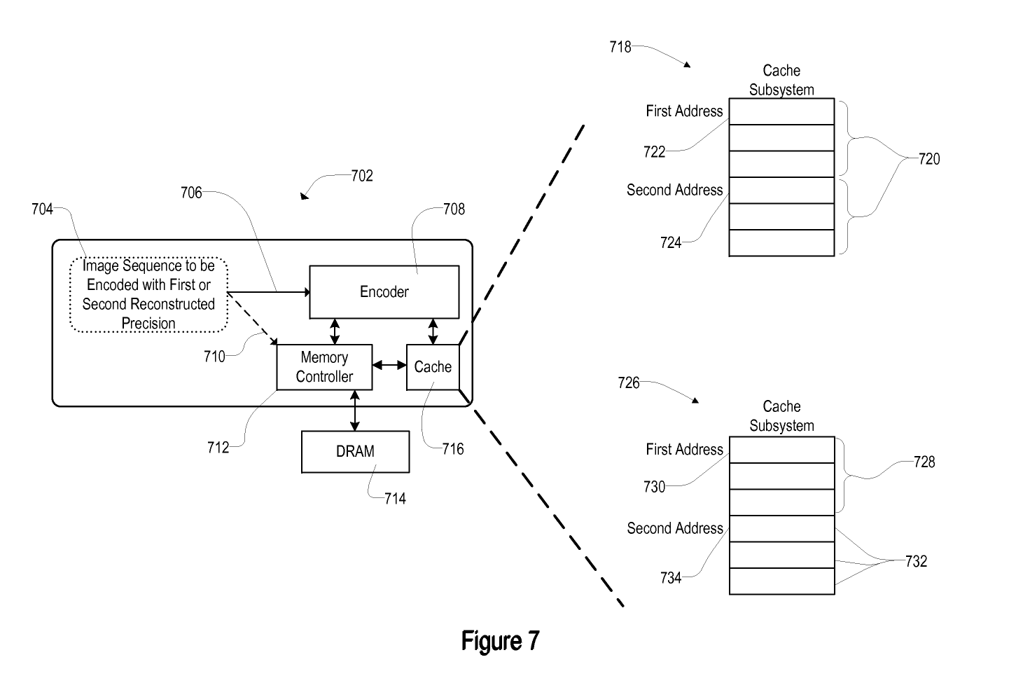

FIG. 7 shows an example of a block diagram of an integrated circuit comprising a video encoder. A plurality of video images comprising an image sequence 704 may be stored in a memory unit and may also be supplied to the integrated circuit 702 from a plurality of sources to be encoded. For example, the image sequence 704 may be supplied from an incoming video stream, memory storage, an external video recorder and other video or image sources. The integrated circuit 702 may be operable to compress the sequence of images 704 into a compressed video stream. The compressed video stream may comprise a first coded video stream and a second video stream defining a first bit precision and a second bit precision respectively.

The image sequence 704 may be delivered 706 to an encoder 708 to be encoded. The image sequence 704 may also be supplied 710 to a memory controller 712, for example a DRAM controller. The memory controller 712 may buffer the image sequence 704 in a memory unit. The memory unit 714 may comprise DRAM, synchronous DRAM (SDRAM) or any other form of memory capable of storing digital data. Once the image sequence is buffered in the memory unit 714, the memory controller 712 may selectively access image data from each image frame of the sequence of images 704. The memory unit may be included as part of the integrated circuit 702 and may also be in communication with the integrated circuit 702. In this implementation, the memory unit 714 is separate from the integrated circuit 702 and in communication with integrated circuit 702 and the memory controller 712.

The image data of the image sequence 704 may be supplied to the encoder 706 or retrieved from the memory unit 714 by the memory controller 712. The image data may then be encoded by the encoder 708 in a high precision mode, or a low precision mode. The high precision mode and the low precision mode may be based on an encoder algorithm and the desired precision of a coded bit stream to be generated by the encoder 708. While encoding the coded bit stream, the encoder 708 may store reference pixel component data for each frame of the image sequence to be encoded in a cache 716. The cache 716 may comprise an interface with the memory controller 712. The interface may allow the cache 716 to request the storage and retrieval of pixel component data from the memory controller 712.

As the encoder 708 encodes and compresses the input video stream, the encoder 708 may selectively access pixel data for a current image frame of the sequence of images 704. To enable various forms of compression, for example motion estimation, the encoder 708 may store pixel data for at least one previous image frame and/or at least one future image frame of the image sequence 704 in the cache 716. The encoder 708 may be configured to rapidly access pixel data for multiple image frames of the image sequence 704. The cache 716 may be configured to provide efficient use of a plurality of addressable storage elements.

When operating in the low precision mode, the encoder may access and store one or more complete pixel component values in a cache subsystem 718 comprising a plurality of addressable storage elements 720. Each of the addressable storage elements 720 may have a first bit precision. The first bit precision may correspond to any number of pixels. In some implementations, each addressable storage element 720 may correspond to a bit precision of a of a complete pixel component value. The first bit precision may further correspond to the bit precision of a low precision video stream. This configuration of the cache 716 may provide for efficient use of the addressable storage elements 720 when processing data having a first precision.

A complete component pixel value may refer to an entire pixel component value as applied in a particular mode of operation. In a low precision mode of operation a complete pixel component value may be defined as an integer value. In a high precision mode of operation, a complete pixel component value may be defined as an integer value and a corresponding fractional value. The term complete as applied herein is used for clarity and should not be considered limiting to the disclosure.

When encoding the coded bit stream, the encoder 708 may access each of the complete pixel component values of at least one reference image frame to compress the sequence of images 704. In this example a first address may be configured to store a first complete pixel component value 722, and a second address may be configured to store a second complete pixel component value 724. The configuration of the addressable storage elements 720 of the cache may provide for efficient storage of complete pixel component values having a first bit precision. By accessing the addressable storage elements 720, the encoder may process a coded bit stream corresponding to the first bit precision. The cache 716 may be configured as illustrated by the cache subsystem 718 to efficiently store video data having a first bit precision by providing addressable storage elements 720 that correspond to the first bit precision.

When operating in a high precision mode, the encoder may access and store one or more partial pixel component values comprising a second bit precision in a cache subsystem 726. One or more integer parts 728 of the pixel component data may be stored in a first address 730 and one or more fractional parts 732 may be stored in a second address 734. The integer parts and the fractional parts may be described as partial pixel component values that may be combined to form complete pixel component values. This configuration of the cache 716 may provide for efficient use of the addressable storage elements 728, 732 when processing data having a second precision. By accessing the addressable storage elements as configured and shown as 720, 728, and 732, the encoder may process a coded bit stream corresponding to the first bit precision and the second bit precision. The coded bit stream generated by the encoder in the high precision mode may correspond to a high precision video stream.

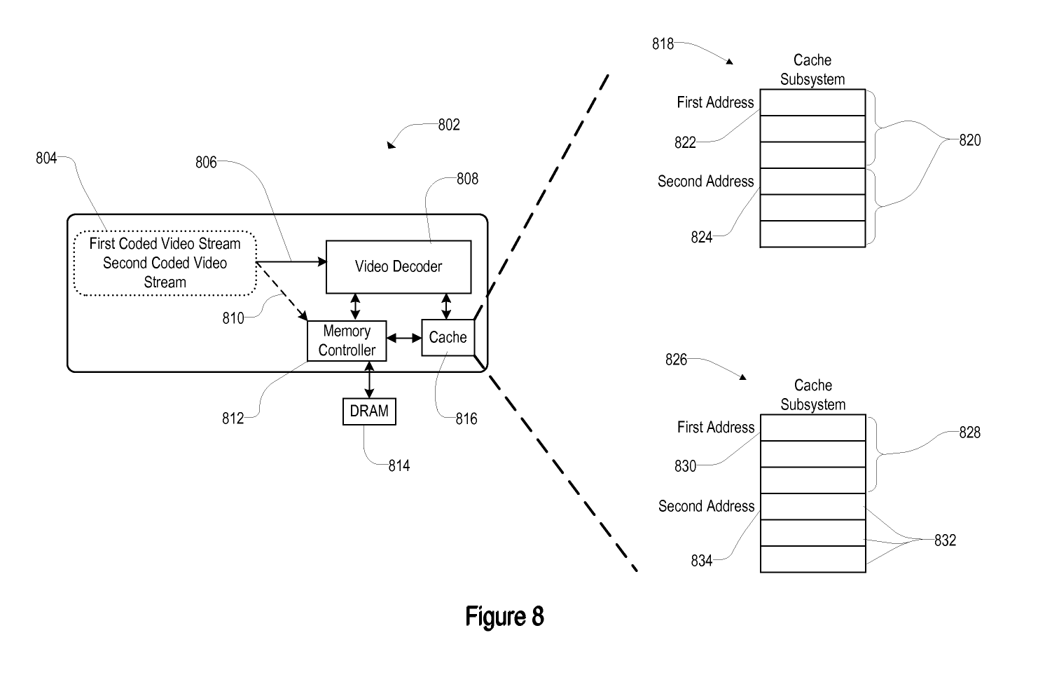

The high precision video stream may be selectively processed in a low precision mode as a low precision video stream as discussed in reference to FIG. 8. Similar to other implementations discussed here, the integrated circuit 702 may selectively activate a low precision mode. The activation of these modes may depend on the desired precision of a compressed video stream. The activation may also be made in response to one or more operating modes including an energy saving mode, user preference, or a limited processing capacity.

FIG. 8 shows an example of a block diagram of an integrated circuit comprising a video decoder. In some instances, the integrated circuit 802 may receive a first coded video stream. Depending on the precision of a source of a compressed video stream, the integrated circuit may receive a first coded video stream and a second coded video stream 804. In this example, the integrated circuit 802 will be described as receiving a first coded video stream and a second coded video stream 804 (hereinafter coded video streams 804). If the integrated circuit 802 receives a first coded video stream comprising only a first precision, the integrated circuit 802 may operate similar to a low precision mode.

The data source for the coded video streams 804 may comprise a plurality of sources, for example, the integrated circuit 702 or a similar encoder, a storage device, a network connection, broadband connection, and other sources of compressed video data. The coded video streams 804 may be supplied 806 to a video decoder 808 for decoding. The coded video streams 804 may also supplied 810 to a memory controller to buffer compressed image frames of the coded video streams 804 to memory. In this implementation each of the coded video streams 804 may be supplied 810 to a memory controller 812 and buffered in a memory unit 814. For example, the memory controller 812 and the memory unit may comprise a DRAM controller and DRAM respectively.

Once the coded video streams 804 are buffered in the memory unit 814, the memory controller 812 may selectively access a plurality of compressed image frames of the coded video streams 804. Depending on a mode of operation, the decoder 808 may operate in a high precision mode or a low precision mode. The activation of these modes may depend on the desired precision of a decoded video feed. The activation may also be made in response to one or more operating modes including an energy saving mode, user preference, or a limited processing capacity. In a low precision mode, the integrated circuit may discard or remove the second coded video stream to preserve memory, cache, and processing bandwidth.

The decoder 808 may access the coded video streams 804 either from the memory controller or as the coded video streams are received 806. The method of delivery of the coded video streams may vary in different implementations. In the low precision mode, the decoder may access and store one or more previously decoded complete pixel component values in cache 816. The cache 816 may comprise an interface with the memory controller 812. The interface may allow the cache 816 to request the storage and retrieval of pixel component data from the memory controller 812. The cache may further comprise a cache subsystem 818 comprising a plurality of addressable storage elements 820. Each of the addressable storage elements 820 may have a first bit precision. The first bit precision may further correspond to the bit precision of a low resolution video stream.

The decoder 808 may access each of the complete pixel component values of at least one decompressed image frame to decompress a sequence of additional images. In this example, a first address 822 may be configured to store a first complete pixel component value, and a second address 824 may be configured to store a second complete pixel component value. By accessing the addressable storage elements 820, the decoder may efficiently process a coded bit stream corresponding to the first bit precision. The cache 816 may be configured as illustrated by the cache subsystem 818 to efficiently store video data having a first bit precision by providing addressable storage elements 820 that correspond to the first bit precision.

When operating in a high precision mode, the decoder may access and store one or more partial pixel component values comprising a first bit precision and a second bit precision in a cache subsystem 826. One or more integer parts 828 of the pixel component data may be stored in a first address 830 and one or more fractional parts 832 may be stored in a second address 834. By accessing the addressable storage elements 820, the decoder may also process a coded bit stream corresponding to the first bit precision. The cache 816 may further be configured to efficiently store video data having a first bit precision and a second bit precision by providing addressable storage elements 828 and 832 that correspond to the first bit precision and the second bit precision. The decoded video stream generated by the decoder in the high precision mode may correspond to a high precision video feed.

The term pixel component value as described herein may refer to any primary, secondary, or ancillary pixel data. The pixel data may relate to any information that may relate to encoding and decoding a video stream and may further relate to other information, for example control information, header data, metadata, etc. In some implementations, the pixel component data may refer to RGB pixel color values, YUV, YCbCr, YCC, Y′CbCr, YPbPr, and other component data for video. Each pixel component value may refer to for example a luma (Y) component value or a chroma value (Cb or Cr). The pixel component data may further correspond to subsampled pixel data in various forms, for example 4:2:0, 4:2:1, 4:2:2, 4:4:4 that may be used to compress pixel data. The precision of each pixel component value may be scaled independently which may generate video data having a variety of bit precisions. The cache disclosed herein may provide for flexible storage for encoding and decoding a variety of coded bit streams of various bit precisions.

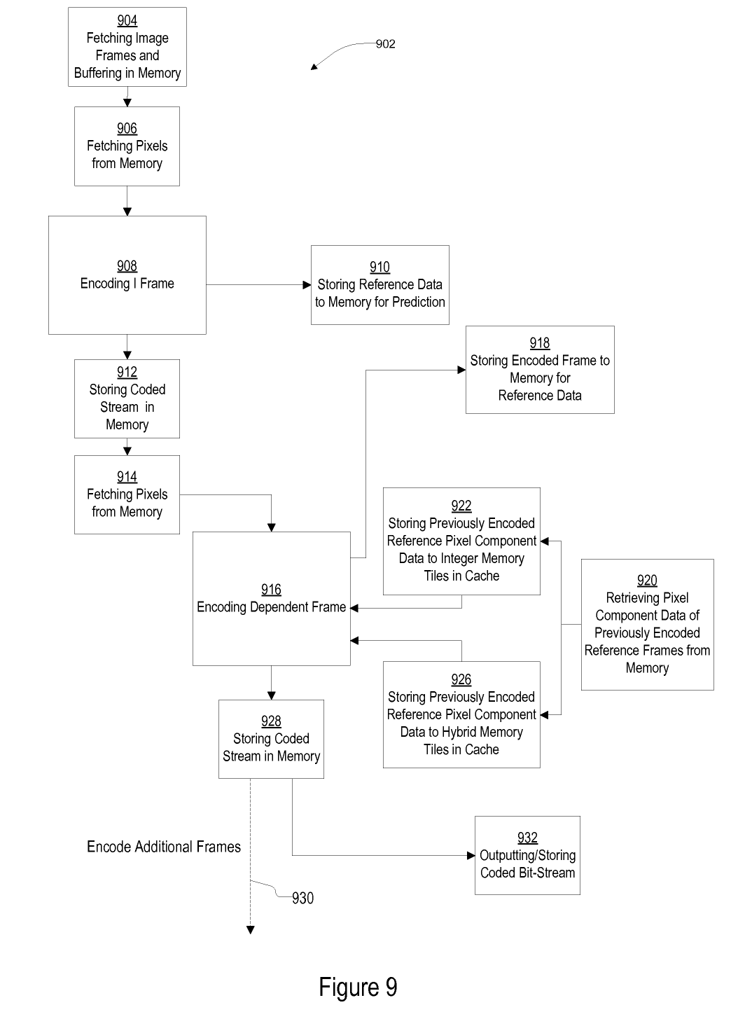

FIG. 9 shows an example of a flow chart of a method 902 for encoding video data having a first bit precision and a second bit precision. The method 902 of encoding data may be initialized in response to the receipt of a video stream. Once initialized, the encoder may fetch image frames of the video stream and buffer the image frame of the video stream into memory, for example DRAM (904). The method may continue to fetch pixels from memory for an I-frame (906). The I-frame may then be encoded based on an encoder algorithm (908).

In this implementation, the encoder may encode at least one image frame in a low precision mode and at least one image frame in a high precision mode. The encoder may encode N-bit data in the low precision mode and N+M-bit data in the high precision mode. As the independent frame is encoded in the high or low precision mode, the encoder may store reference data to memory for prediction (910). The data may later be accessed and stored in a cache to encode one or more dependent frames. The encoder may also store the encoded, independent frame in a coded bit stream in memory (912).

The next image frame read from memory by the encoder may be encoded as a dependent frame (914). For example, a dependent frame may comprise a P-frame, B-frame or other types of dependent coded image frames. The dependent frame may be dependent on an I-frame or another dependent frame. The I-frame or another dependent frame may be used for motion estimation of the dependent frame. For motion estimation, the dependent frame may optionally not require high precision data, and may be encoded in a low precision mode (N-bit). The low precision mode may be applied to lower processing requirements on the encoder and limit the memory bandwidth usage. The encoder may further begin encoding the dependent frame in a high or low precision mode (916). The encoded frame may further be stored to memory as reference data for other dependent frames (918).

Depending on the mode of operation, the encoder may store pixel component data in integer and hybrid storage elements as low precision data or high precision data. The encoder may retrieve pixel component data of previously encoded reference frames from memory as integer data from memory (920). The reference pixel component data may then be stored in integer memory tiles in a cache (922). In the high precision mode, fractional data corresponding to the integer data may be stored in hybrid memory tiles in the cache. The encoder may also retrieve pixel component data of previously encoded reference frames from memory as fractional data from memory (920). The fractional data may further be stored in hybrid memory tiles in the cache (926).

In the low precision mode of operation, the fractional memory tiles may also be configured to store integer data in a plurality of hybrid memory tiles. By selectively utilizing the hybrid memory tiles to store integer and fractional data, the cache may be implemented efficiently. In the low and the high precision modes, the encoder may selectively access the integer storage elements and hybrid storage elements in the cache.

As the dependent frame is encoded, a coded stream of data may be stored in memory (928). After completion of the dependent frame, the encoding process may continue by encoding additional image frames (930). The frame that follows the dependent frame may be another dependent frame (e.g. P-Frame, B-frame) or a new I-frame. The encoding process may continue as disclosed herein until each frame of the incoming video stream is encoded. The coded video stream may be output from the encoder during the encoding process or stored for later decoding or transmission (932).

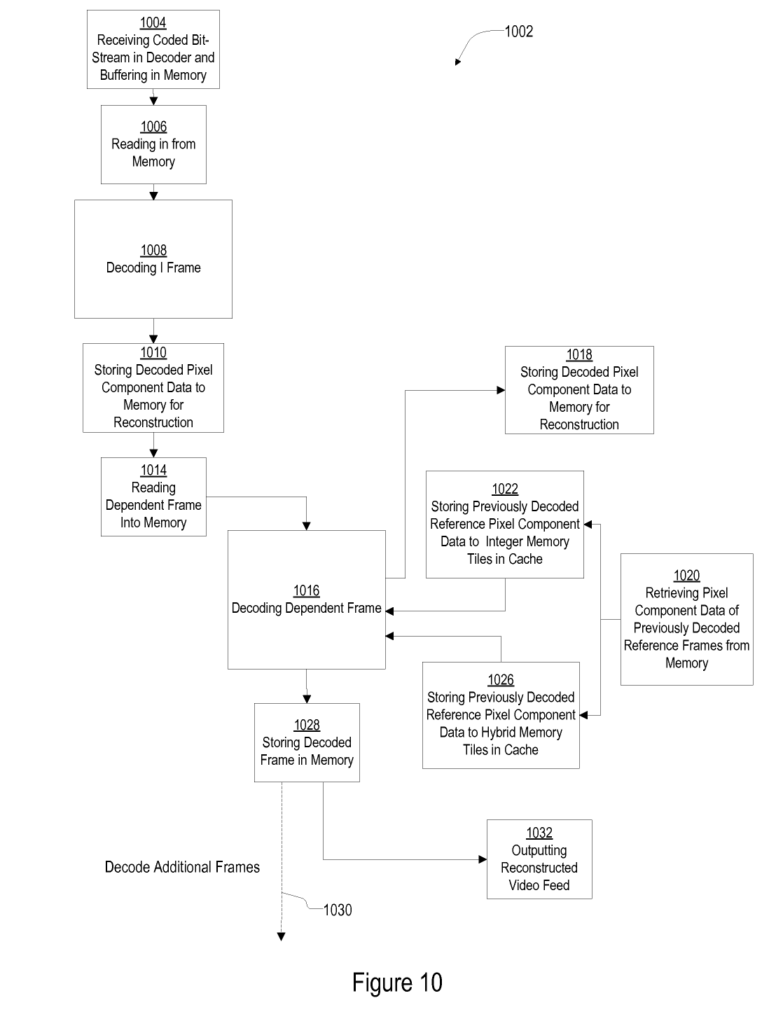

FIG. 10 shows an example of a flow chart of a method 1002 for decoding video data having a first bit precision and a second bit precision. A compressed video stream as introduced in FIG. 9 may be decoded by a system similar to that introduced in FIG. 5. The method 1002 of decoding video data having a first bit precision and a second bit precision may comprise a decoder receiving a coded bit stream and buffering a plurality of compressed image frames of the bit stream in memory (1004). The decoder may then continue to read a coded I-frame from the memory (1006).

With the coded I-frame in memory, the decoder may decode and reconstruct the I-frame by accessing decompressed pixel data and compression data (1008). The decoder may reconstruct N-bit data in the low precision mode and N+M-bit data in the high precision mode. While processing the frame, the decoder may store reference data to memory for reconstruction (1010). Next, the decoder may read another frame of the compressed video stream, for example a dependent frame from the memory (1014).

In order to decode the dependent frame, the decoder may request and store data to memory for reconstruction. The dependent frame may then be decoded in response to the level of precision in which it was encoded or the mode of decoding precision (1016). The decoder may store decoded data for the dependent frame to memory for reconstruction (1018). Reference pixel component data of previously decoded reference frames may be retrieved from memory as integer and fractional data (1020). The integer data may be stored in integer memory tiles in the cache for access during decoding (1022).

In the high precision mode, fractional data corresponding to the integer data may be retrieved from memory. The fractional data from the previously decoded reference data may then be stored in hybrid memory tiles in the cache (1026). In the low precision mode, a plurality of hybrid tiles may be applied to store at least one integer data element. By flexibly applying the hybrid storage elements, the disclosure may provide for efficient use of the cache.

Upon completion of decoding the dependent frame, the decoding process may continue by storing the dependent frame in memory (1028). The method may then continue to decode additional video frames of the video stream (1030). During the decoding process, a reconstructed video feed may be output to a display for viewing (1032). The video codec and methods disclosed herein may provide the efficient utilization of cache and transmitting video having high precision while decreasing the memory and bandwidth requirements.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

Various implementations have been specifically described. However, many other implementations are also possible.

What is claimed is:

1. A method for storing video data comprising:
receiving a first set of pixel data at a first bit precision;
receiving a second set of pixel data at a second bit precision, the second bit precision being greater than the first bit precision;
storing pixel data corresponding to the first set of pixel data into a first memory tile; and
storing a first part of the pixel data corresponding to the second set of pixel data into the first memory tile and a second part of the pixel data corresponding to the second set of pixel data into a second memory tile.

2. The method according to claim 1, wherein the first memory tile and the second memory tile comprise a plurality of addressable storage elements in a cache.

3. The method according to claim 2, wherein the capacity of addressable storage elements of the first memory tile is an integer multiple of the first bit precision.

4. The method according to claim 2, wherein the capacity of addressable storage elements of the second memory tile is an integer multiple of the difference between the first bit precision and the second bit precision.

5. The method according to claim 1, further comprising retrieving the first set of pixel data from the first memory tile at the first bit precision, and retrieving the second set of pixel data from the first memory tile and the second memory tile at the second bit precision.

6. The method according to claim 1, wherein the first memory tile holds the most significant bits of the second set of pixel data and the second memory tile holds the least significant bits of the second set of pixel data.

7. The method according to claim 1, further comprising receiving the second video stream and outputting a sequence of reconstructed video frames at the first bit precision in response to a low precision mode of operation.

8. The method according to claim 7, wherein the low precision mode of operation is activated in response to a power saving mode.

9. A system for generating a coded bit stream, the system comprising:
an integrated circuit comprising an encoder, the encoder configured to:
receive pixel component data of an image frame;
generate a coded bit stream representing a first bit precision in a first mode of encoding precision; and
generate a coded bit stream representing a second bit precision in a second mode of encoding precision;
the integrated circuit further comprising a cache, the cache being operable to:
store a first set of the pixel component data at a first bit precision into a first memory tile in response to a first mode of encoding precision; and
store a second set of the pixel component data at a second bit precision into the first memory tile and a second memory tile in response to a second mode of encoding precision.

10. The system according to claim 9, wherein the first memory tile and the second memory tile comprise a plurality of addressable memory storage elements.

11. The system according to claim 9, wherein the first memory tile corresponds to the first bit precision and the second memory tile corresponds to the difference between the second bit precision and the first bit precision.

12. The system according to claim 9, wherein the cache comprises at least one hybrid memory tile that is configured in a first mode to have storage elements of the first bit precision and configured in a second mode to have storage elements of the difference between the first bit precision and second bit precision.

13. The system according to claim 9, wherein the first mode of encoding precision is activated in response to a compatibility of a device receiving the coded bit stream.

14. An apparatus for processing pixel data, the apparatus comprising:
a processor configured to process video data from a pixel data source comprising pixel component data, the pixel component data comprising a first bit precision and a second bit precision;
a set of on-chip addressable storage elements comprising a plurality of integer storage elements corresponding to the first bit precision and a plurality of fractional storage elements corresponding to the difference between the first bit precision and the second bit precision;
the processor comprising at least one module configured to:
configure control bits to control the arrangement of the pixel component data among the integer storage elements and the fractional storage elements in response to the pixel component data corresponding to the first bit precision or the second bit precision.

15. The apparatus according to claim 14, wherein the on-chip addressable storage elements are accessed as an on-demand cache.

16. The apparatus according to claim 14, wherein the on-chip addressable storage elements are accessed as a managed cache.

17. The apparatus according to claim 14, wherein the control bits may be configured to assign a plurality of fractional storage elements to store data at the first bit precision.

18. The apparatus according to claim 14, wherein the plurality of integer storage elements corresponds to the most significant bits of the pixel component data and the fractional storage elements correspond to the least significant bits of the pixel component data.

19. The apparatus according to claim 14, wherein the processor comprises at least one of a video encoder, a video decoder, or a frame rate converter.

20. The apparatus according to claim 14, wherein the on-chip addressable storage elements are a texture cache unit and the processor is a graphics processing unit.
